(19) United States
(12) Patent Application Publication
(10) Pub. No.: US 2008/0024371 A1
(43) Pub. Date: Jan. 31, 2008

(54) MONOPOLE ANTENNA

(75) Inventor: YEN-YI SHIH, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/615,010

(22) Filed: Dec. 22, 2006

(30) Foreign Application Priority Data
Jul. 28, 2006 (TW) 95127769

(51) Int. Cl. H01Q 1/24

(52) U.S. Cl. 343/702; 343/700 MS

(57) ABSTRACT

A monopole antenna (10) includes a feed wire (14), a radiation part (18), and a matching part (16). The feed wire is formed on a clear portion of a substrate for feeding electromagnetic signals. The radiation part is connected to the feed wire for radiating and receiving electromagnetic signals, and includes a first radiation part (180) and a second radiation part (182). The second radiation part is connected to the first radiation part, the first radiation part is formed on a first plane, and the second radiation part is formed on a second plane intersecting the first plane. The matching part is connected to the radiation part for impedance matching.

### BACKGROUND OF THE INVENTION

1. Field of the Invention

The invention relates to antennas, and particularly to a monopole antenna in a wireless local area network (WLAN) device.

2. Description of Related Art

Growing demands in the mobile communication industry stimulate quick developments of mobile communication technologies. Code division multiple access (CDMA) technology is one such technology, and becomes more popular due to large traffic volume and its better communication quality.

To meet market expectations, mobile phones with CDMA technology should be designed ever smaller. Antennas are key elements of mobile phones and must be considered in any effort to reduce the size of mobile phones.

However, common antennas employed by mobile phones are planar inverted-F antennas with a pogo pin, which are rather expensive, and are not easily reduced in size.

### SUMMARY OF THE INVENTION

One aspect of the invention provides a monopole antenna, including a feed wire, a radiation part, and a matching part. The feed wire is formed on a clear portion of a substrate for feeding electromagnetic signals. The radiation part is connected to the feed wire for radiating and receiving electromagnetic signals, and includes a first radiation part and a second radiation part. The second radiation part is connected to the first radiation part, the first radiation part is formed on a first plane, and the second radiation part is formed on a second plane intersecting the first plane. The matching part is connected to the radiation part for impedance matching.

Another aspect of the invention provides a monopole antenna, fixed on a substrate, including a feed wire, a radiation part, and a matching part. The feed wire is electronically connected to the substrate, and is used for feeding electromagnetic signals. The radiation part is electronically connected to the feed wire, and is used for radiating and receiving electromagnetic signals, including a plurality of radiation parts formed on at least two intersecting planes. The matching part is electronically connected to the feed wire, for impedance matching.

The radiation part is formed with metal on at least two planes, thus eliminating the need for pogo pins, thereby, minimizing the profile of the monopole antenna.

Other advantages and novel features will become more apparent from the following detailed description when taken in conjunction with the accompanying drawings, in which:

### BRIEF DESCRIPTION OF THE DRAWINGS

FIG. 1 is a schematic view of a monopole antenna of an exemplary embodiment of the present invention;

FIG. 2 is a graph of test results showing return loss of the monopole antenna of FIG. 1.

### DETAILED DESCRIPTION OF THE INVENTION

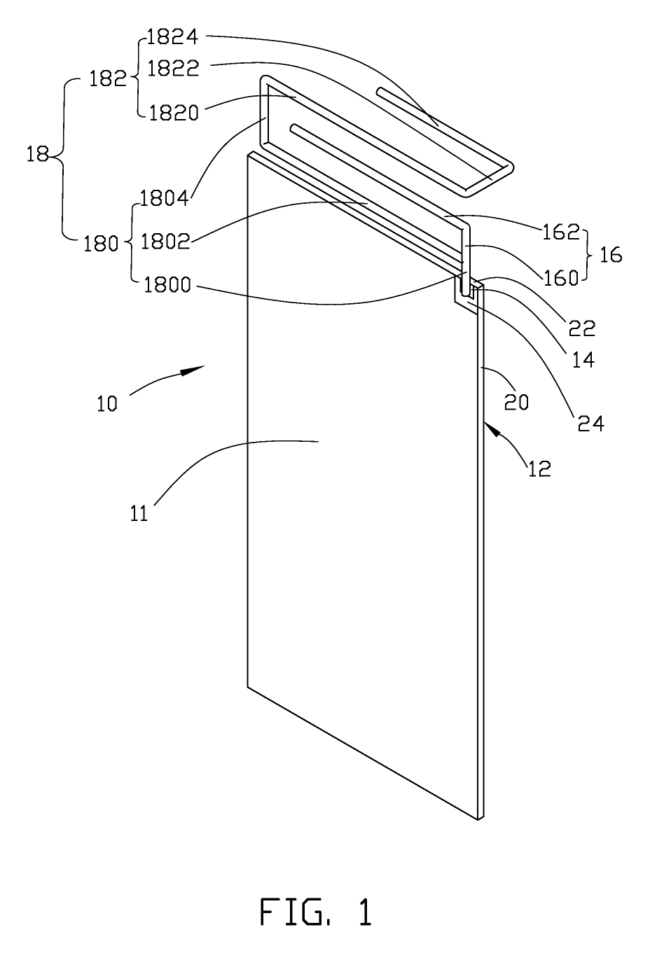

FIG. 1 is a schematic view of a monopole antenna 10 of an exemplary embodiment of the present invention. In the exemplary embodiment, the monopole antenna 10 includes a feed wire 14, a radiation part 18, and a matching part 16. The feed wire 14 is configured on a substrate 20, and is used for feeding electromagnetic signals. In the exemplary embodiment, the substrate 20 is a printed circuit board (PCB), and includes a first surface 11 and a second surface 12. The first surface 11 has a clear portion 24 on a corner of the first surface 11, and the feed wire 14 is configured on the clear portion 24. In the exemplary embodiment, the feed wire 14 is positioned on the center of the clear portion 24.

In the exemplary embodiments, the radiation part 18 is provided for radiating and receiving electromagnetic signals, and includes a plurality of radiation parts formed on at least two planes. In the exemplary embodiment, the radiation part 18 includes a first radiation part 180 and a second radiation part 182. The first radiation part 180 is integrated with the second radiation part 182.

In the exemplary embodiment, the first radiation part 180 is formed on a first plane, and the second radiation part 182 is formed on a second plane. In the exemplary embodiment, the first plane is substantially perpendicular to the second plane, and the first plane is substantially parallel to the substrate 20.

In the exemplary embodiment, the first radiation part 180 includes a first radiation segment 1800, a second radiation segment 1802, and a third radiation segment 1804, which co-form the first plane. One end of the first radiation segment 1800 is connected to the feed wire 14. One end of the second radiation segment 1802 is connected to the other end of the first radiation segment 1800, the other end of the second radiation segment 1802 is connected to one end of the third radiation segment 1804, and the second radiation segment 1802 is substantially parallel to the side 22 of the substrate 20. The third radiation segment 1804 is substantially parallel to the first radiation segment 1800. In the exemplary embodiment, the second radiation segment 1802 is perpendicular to the first radiation segment 1800 and the third radiation segment 1804.

The second radiation part 182 includes a fourth radiation segment 1820, a fifth radiation segment 1822, and a sixth radiation segment 1824, which co-form the second plane. One end of the fourth radiation segment 1820 is connected to the third radiation segment 1804, and the fourth radiation segment 1820 is parallel to the second radiation segment 1802. In the exemplary embodiment, the fourth radiation segment 1820 is substantially perpendicular to the third radiation segment 1804.

One end of the fifth radiation segment 1822 is connected to the other end of the fourth radiation segment 1820, and the fifth radiation segment 1822 is substantially perpendicular to the first plane formed by the first radiation part 180. In the exemplary embodiment, the fifth radiation segment 1822 is substantially perpendicular to the fourth radiation segment 1820. One end of the sixth radiation segment 1824 is connected to the other end of the fifth radiation segment 1822, and the other end of the sixth radiation segment 1824 is unconnected, and the sixth radiation segment 1824 is parallel to the fourth radiation segment 1820. In the exemplary embodiment, the sixth radiation segment 1824 is substantially perpendicular to the fifth radiation segment 1822.

The matching part 16 is used as impedance matching, and includes a first matching segment 160 and a second matching segment 162. The matching part 16 is disposed on the first plane, one end of the first matching segment 160 is connected to the other end of the first radiation segment 1802, the other end of the first matching segment 160 is connected to one end of the second matching segment 162, the other end of the second matching segment 162 is unconnected. The first matching segment 160 is parallel to the third radiation segment 1804, the first matching segment 160 and the first radiation segment 1800 are located in a same line, and lengths of the first matching segment 160 and the first radiation segment 1800 are equal.

In the exemplary embodiment, the first matching segment 160 is perpendicular to the second matching segment 162 and the second radiation segment 1802. The second matching segment 162 is parallel to the second radiation segment 1802 and the fourth radiation segment 1820, distances between the second matching segment 162 and the second radiation segment 1802 and between the second matching segment 162 and the fourth radiation segment 1820 are equal.

In the exemplary embodiment, the first radiation segment 1800, the second radiation segment 1802, the third radiation segment 1820, the fifth radiation segment 1822, the sixth radiation segment 1824, the first matching segment 160, and the second matching segment 162 are all columnar.

In the exemplary embodiment, a length and a diameter of the first radiation segment 1800 are respectively 5 mm and 1 mm. A length and a diameter of the second radiation segment 1802 are respectively 35 mm and 1 mm. A length and a diameter of the third radiation segment 1820 are respectively 10 mm and 1 mm. A length and a diameter of the fourth radiation segment 1822 are respectively 35 mm and 1 mm. A length and a diameter of the fifth radiation segment 1824 are respectively 8 mm and 1 mm. A length and a diameter of the sixth radiation segment 1824 are respectively 23 mm and 1 mm. A length and a diameter of the first matching segment 160 are respectively 5 mm and 1 mm. A length and a diameter of the second matching segment 162 are respectively 30 mm and 1 mm.

In the preferred embodiment the perpendicular relationships described between various parts of the present invention may be at angles other than perpendicular in alternative exemplary embodiments, and lengths and widths of elements of the monopole antenna 10 can be changed.

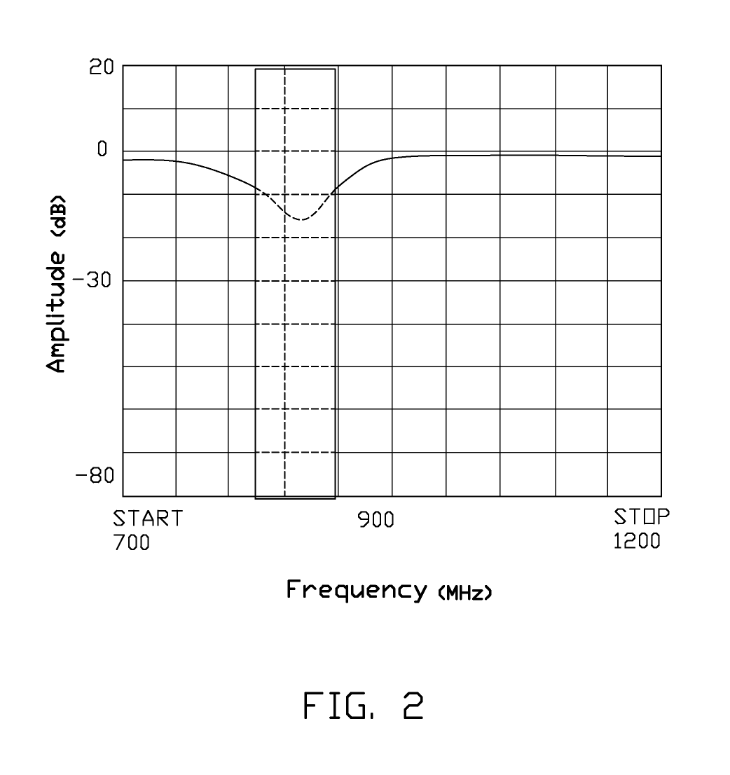

FIG. 2 is a graph of test results showing return loss of the monopole antenna 10 of FIG. 1. As shown, when the monopole antenna 10 operates at working frequency bands of 824˜894 MHz, its return loss is less than −8 dB. This indicates that the working frequency of the monopole antenna 10 covers CDMA frequency bands.

In the exemplary embodiment, the radiation part 18 is formed with metal on at least two planes, thus eliminating a need for pogo pins, thereby, minimizing the profile of the monopole antenna 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A monopole antenna, comprising:
a feed wire formed on a clear portion of a substrate, for feeding electromagnetic signals;
a radiation part connected to the feed wire, for radiating and receiving electromagnetic signals, the radiation part comprising a first radiation part and a second radiation part connected to the first radiation part, the first radiation part formed on a first plane, the second radiation part formed on a second plane intersecting the first plane; and
a matching part connected to the radiation part, for impedance matching.

2. The monopole antenna of claim 1, wherein the first plane is parallel to a surface of the substrate, and is perpendicular to the second plane.

3. The monopole antenna of claim 1, wherein the first radiation part is integrated with the second radiation part, and the second radiation part is perpendicular to the first radiation part.

4. The monopole antenna of claim 1, wherein the first radiation part comprises a first radiation segment, a second radiation segment, and a third radiation segment, the first radiation segment connecting to the feed wire and the matching part, and the second radiation segment connecting to the first radiation segment and the third radiation segment.

5. The monopole antenna of claim 4, wherein the first radiation segment is parallel to the third radiation segment, and the second radiation segment is perpendicular to the first radiation segment and the third radiation segment.

6. The monopole antenna of claim 4, wherein the matching part comprises a first matching segment and a second matching segment, the first matching segment electronically connecting the first radiation part with the second matching segment.

7. The monopole antenna of claim 6, wherein the first matching segment is parallel to the third radiation segment, the first matching segment is perpendicular to the second radiation segment, and the matching part is formed on the first plane.

8. The monopole antenna of claim 1, wherein the second radiation part comprises a fourth radiation segment, a fifth radiation segment, and a sixth radiation segment, and the fifth radiation segment connecting to the fourth radiation segment and the sixth radiation segment.

9. The monopole antenna of claim 8, wherein the fourth radiation segment is parallel to the sixth radiation segment, the fifth radiation segment is perpendicular to the fourth radiation segment and the sixth radiation segment, and the fifth radiation segment is perpendicular to the first plane.

10. The monopole antenna of claim 1, wherein the feed wire is formed on a center of the clear portion.

11. A monopole antenna, fixed on a substrate, comprising:
a feed wire electronically connected to the substrate, for feeding electromagnetic signals;
a radiation part electronically connected to the feed wire, for radiating and receiving electromagnetic signals, the radiation part comprising a plurality of radiation parts formed on at least two intersecting planes; and
a matching part electronically connected to the feed wire, for impedance matching.

12. The monopole antenna of claim 11, wherein the radiation part comprises a first radiation part and a second radiation part, respectively formed in the first plane and the second plane.

13. The monopole antenna of claim 12, wherein the first radiation part comprises a first radiation segment connected to a second radiation segment, which in turn is connected to a third radiation segment.

14. The monopole antenna of claim 11, wherein the matching part comprises a first matching segment and a second matching segment, the first matching segment is perpendicularly connected to the first radiation part, and the matching segment is perpendicularly connected to the first matching segment.

15. The monopole antenna of claim 11, wherein the second radiation part comprises a fourth radiation segment connected to a fifth radiation segment, which in turn is connected to a sixth radiation segment.

16. The monopole antenna of claim 11, wherein the substrate comprises a clear portion, and the feed wire is disposed on the center of the clear portion.

17. An antenna assembly comprising:
a substrate; and
an antenna disposed on said substrate and extending away from said substrate, said antenna comprising a feed wire electrically connectable to said substrate for feeding electromagnetic signals to said antenna, a radiation part electrically connectable with said feed wire and extending away from said feed wire for radiating and receiving electromagnetic signals, said radiation part comprising a first radiation part electrically connectable with said feed wire and extending along a predefined plane, and a second radiation part electrically connectable with said first radiation part and extending angularly away from said first radiation part and said predefined plane.

18. The antenna assembly of claim 17, wherein said second radiation part extends perpendicularly to said predefined plane along which said first radiation part extends.

19. The antenna assembly of claim 17, further comprising a matching part for impedance matching electrically connectable with said feed wire and extending away from said feed wire to be located between said first and second radiation parts.
